(19) United States
(12) Patent Application Publication
(10) Pub. No.: US 2026/0014955 A1
(43) Pub. Date: Jan. 15, 2026

(54) AIRBAG STRUCTURE

(71) Applicant: TOYODA GOSEI CO., LTD., Kiyosu-shi (JP)

(72) Inventors: Ryoichi KATO, Kiyosu-shi (JP); Junpei HAMAMOTO, Kiyosu-shi (JP)

(21) Appl. No.: 19/236,580

(22) Filed: Jun. 12, 2025

(30) Foreign Application Priority Data
Jul. 10, 2024 (JP) 2024-111348

(51) Int. Cl. B60R 21/215; B60R 13/02; B60R 21/214

(52) U.S. Cl. CPC B60R 21/215; B60R 13/0212; B60R 21/214; B60R 2021/21518; B60R 2021/21537

(57) ABSTRACT

A ceiling panel is prevented from falling from a bag cover when an airbag deploys and expands. An airbag structure includes: an airbag; a bag cover to which the airbag is attached, the bag cover being fixed to a vehicle body; a ceiling panel integrated with the bag cover, the ceiling panel forming a storage space for storing the airbag between the bag cover and the ceiling panel, the ceiling panel opening the storage space by opening with respect to the bag cover, and exposing the airbag toward inside of a vehicle when the airbag deploys and expands; and a falling-off preventing structure disposed between the bag cover and the ceiling panel, the falling-off preventing structure preventing the ceiling panel from falling from the bag cover.

### TECHNICAL FIELD

The present disclosure relates to an airbag structure mounted to a vehicle.

### BACKGROUND ART

To date, a bag-shaped airbag for mainly protecting the head of an occupant during collision of a vehicle has been known (see, for example, JP2017-47745A). The airbag extends along an edge portion of a vehicle ceiling. The airbag deploys and expands toward the inside of the vehicle relative to a side window of a side door during collision of the vehicle. The deployment and expansion of the airbag allows the head of an occupant to be mainly protected during collision of the vehicle.

The airbag disclosed in JP2017-47745A is covered by a bag cover on the outer side of the vehicle, and is attached to the bag cover at an attachment portion disposed at a flange-like protruding portion. The airbag is positioned relative to a vehicle body by fixing the airbag itself and the bag cover to the vehicle body by a clip, a bolt, or the like. Furthermore, the airbag is covered by a ceiling panel on the inner side of the vehicle. The airbag is stored in a storage space formed between the bag cover and the ceiling panel. The ceiling panel is formed as a separate component from the bag cover, and is supported by the bag cover with an attachment portion such as a clip. When the airbag deploys and expands, the ceiling panel opens with respect to the bag cover by the expansion force of the airbag, and the airbag deploys toward the inside of the vehicle.

### SUMMARY OF INVENTION

### TECHNICAL PROBLEM

In the airbag disclosed in JP2017-47745A, as described above, the bag cover and the ceiling panel are formed as separate components, and are attached to each other with the attachment portion. However, in such a structure, when the ceiling panel opens with respect to the bag cover to open the storage space by deployment and expansion of the airbag, the ceiling panel is likely to fall from the bag cover due to, for example, the attachment portion such as a clip being detached. If the ceiling panel falls from the bag cover while the airbag is deploying and expanding, safety of an occupant is likely to be compromised.

The present disclosure has been made in view of the aforementioned circumstances, and an object of the present disclosure is to provide an airbag structure that prevents a ceiling panel from falling from a bag cover while an airbag is deploying and expanding.

### SOLUTION TO PROBLEM

One aspect of the present disclosure is directed to an airbag structure including: an airbag; a bag cover to which the airbag is attached, the bag cover being fixed to a vehicle body; a ceiling panel integrated with the bag cover, the ceiling panel forming a storage space for storing the airbag between the bag cover and the ceiling panel, the ceiling panel opening the storage space by opening with respect to the bag cover, and exposing the airbag toward inside of a vehicle when the airbag deploys and expands; and a falling-off preventing structure disposed between the bag cover and the ceiling panel, the falling-off preventing structure preventing the ceiling panel from falling from the bag cover.

In this configuration, the ceiling panel is prevented from falling from the bag cover when the airbag deploys and expands.

### BRIEF DESCRIPTION OF DRAWINGS

FIG. 1 is a side view of a vehicle inside of a vehicle to which an airbag structure according to one embodiment of the present disclosure is mounted;

FIG. 2 is a side view of a ceiling panel in a closed state in the airbag structure according to the embodiment;

FIG. 3 is a perspective view of the ceiling panel in an opened state in the airbag structure according to the embodiment;

FIG. 4 is a perspective view of the ceiling panel in an opened state in the airbag structure (excluding an airbag) according to the embodiment;

FIG. 5 is a perspective view of an airbag which is applied to the airbag structure according to the embodiment;

FIG. 6 is a cross-sectional view of the airbag structure according to the embodiment as taken along a straight line VI-VI in FIG. 2;

FIG. 7 is a cross-sectional view of the airbag structure according to the embodiment as taken along a straight line VII-VII in FIG. 2;

FIG. 8 is a cross-sectional view of the ceiling panel in an opened state at a portion including a hinge portion of the airbag structure according to the embodiment;

FIG. 9 is a perspective view of a ceiling panel in an opened state in an airbag structure (excluding the airbag) according to a first modification of the present disclosure;

FIG. 10 is a perspective view of a ceiling panel in an opened state in an airbag structure (excluding the airbag) according to a second modification of the present disclosure;

FIG. 11 is a cross-sectional view of the ceiling panel in a closed state at a portion including a tether clip portion of the airbag structure according to each of the first modification and the second modification;

FIG. 12 is a cross-sectional view of the ceiling panel in an opened state at the portion including the tether clip portion of the airbag structure according to each of the first modification and the second modification;

FIG. 13 is a perspective view of a ceiling panel in an opened state in an airbag structure (excluding the airbag) according to a third modification of the present disclosure;

FIG. 14 is a perspective view of the ceiling panel in an opened state in the airbag structure according to the third modification;

FIG. 15 is a perspective view of a ceiling panel in an opened state at a first bag cover and a first falling-off preventing structure of an airbag structure (excluding the airbag) according to a fourth modification of the present disclosure; and

FIG. 16 is a perspective view of a ceiling panel in an opened state at a second bag cover and a second falling-off preventing structure of the airbag structure (excluding the airbag) according to the fourth modification.

### DESCRIPTION OF EMBODIMENTS

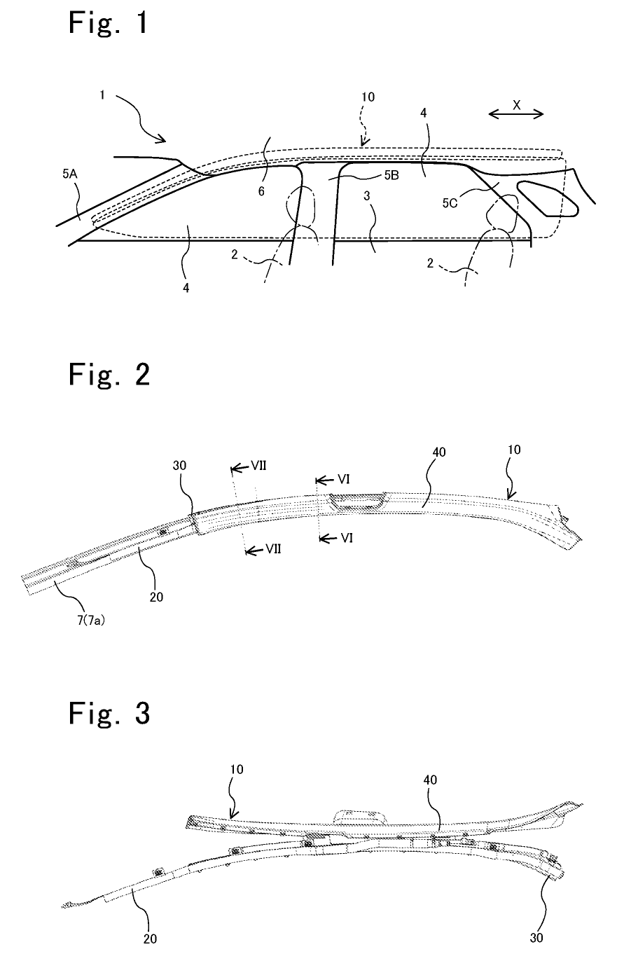

Airbag structures according to a specific embodiment and the like of the present disclosure are described below with reference to FIG. 1 to FIG. 16. The “front”, “rear”, “right”, “left”, “upper”, and “lower” in the present embodiment represent directions relative to the direction of the vehicle to which the airbag structure is mounted. For example, the “front” represents the leading side of an advancing vehicle.

An airbag structure 10 of the present embodiment is mounted to a vehicle 1 and protects the head of an occupant seated in a seat 2 by using an airbag during collision of the vehicle 1. The vehicle 1 is an engine automobile, an electric vehicle, a fuel cell vehicle, or the like, and is an automobile in which a space in the vehicle is separated from the outside of the vehicle by a side door 3, a side window 4, an A pillar 5A, a B pillar 5B, a C pillar 5C, and a vehicle ceiling 6, as shown in FIG. 1.

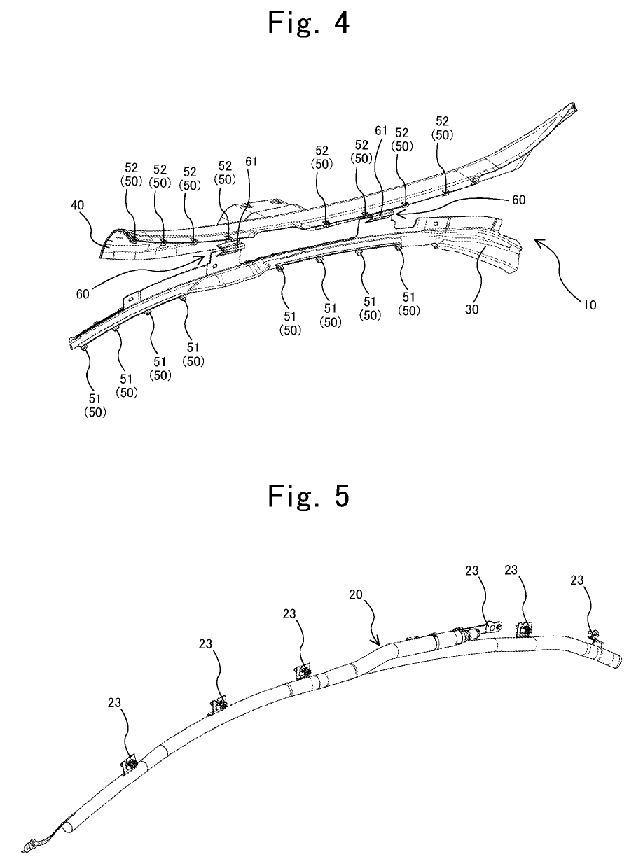

The airbag structure 10 is structured to store and hold an airbag such that the airbag is allowed to deploy and expand. As shown in FIG. 2, FIG. 3, and FIG. 4, the airbag structure 10 includes an airbag 20, a bag cover 30, a ceiling panel 40, a lock-engagement portion 50, and a falling-off preventing structure 60.

The airbag 20 is a curtain airbag for mainly protecting the head of an occupant during collision of the vehicle 1. The airbag 20 is formed in a bag-like shape in order to allow a fluid generated for expansion by an inflator (not shown) to flow thereinto. For example, the airbag 20 is formed of fabric obtained by weaving yarns made of nylon, or the like. As shown in FIG. 5, the airbag 20 extends in a rail-like form in a vehicle front-rear direction X along an edge portion of the vehicle ceiling 6 on the side window 4 and pillar 5A, 5B, 5C sides. The airbags 20 are disposed on the left side and the right side so as to correspond to the seats 2 on the left side and the right side, respectively, of the vehicle 1.

The airbag 20 is folded before deployment and expansion. The airbag 20 deploys and expands from the folded state when a fluid for expansion flows into the airbag 20. The airbag 20 deploys and expands from the edge portion of the vehicle ceiling 6 toward the inside of the vehicle relative to the side window 4 and the pillars 5A, 5B, 5C. The airbag 20 starts to deploy toward the inside of the vehicle, and is thus inserted into a space between an occupant seated in the seat 2, and the side window 4 and the pillars 5A, 5B, 5C, and expands so as to cover the surfaces of the side window 4 and the pillars 5A, 5B, 5C on the vehicle inner side. Thus, the head of the occupant is mainly protected during collision of the vehicle 1.

The bag cover 30 is a case member to which the airbag 20 is attached. The bag cover 30 extends in a rail-like form in the vehicle front-rear direction X along the edge portion of the vehicle ceiling 6. The bag cover 30 may be formed such that a front portion in the longitudinal direction is inclined downward from the rear side toward the front side, and the rear portion in the longitudinal direction is inclined downward from the front side toward the rear side.

As shown in FIG. 7, the airbag 20 has an attachment portion 21. The attachment portion 21 is a portion for attaching the airbag 20 to the bag cover 30, eventually, to a vehicle body 7. The attachment portion 21 is disposed at a flange-like protrusion 23 that protrudes upward from a body of the airbag 20. The attachment portion 21 is implemented by an attachment hole into which a clip or a bolt (hereinafter, referred to as clip or the like 22; see FIG. 5 and FIG. 7) is inserted. The protrusions 23 are disposed at a plurality of portions (six portions in FIG. 5, etc.) in the airbag 20 so as to be spaced from each other in the vehicle front-rear direction X. The attachment portions 21 are disposed at a plurality of portions so as to be spaced from each other in the vehicle front-rear direction X.

The plurality of the attachment portions 21 may include an attachment portion for attaching the airbag 20 directly to the vehicle body 7 without using the bag cover 30 as well as the attachment portion for attaching the airbag 20 to the vehicle body 7 through the bag cover 30.

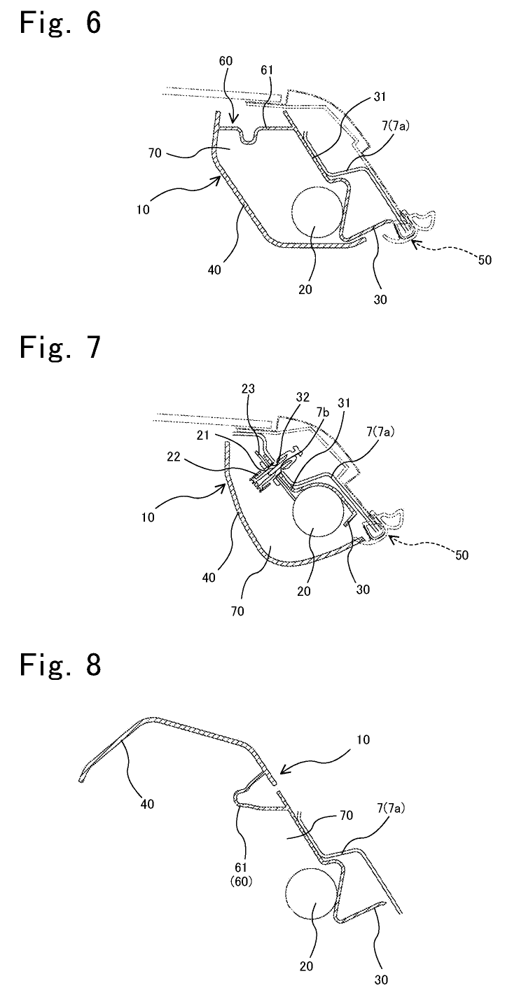

The bag cover 30 is disposed along the edge portion of the vehicle ceiling 6. The bag cover 30 is formed so as to store and hold the airbag 20. As shown in FIG. 6 and FIG. 7, the bag cover 30 has a wall portion 31 extending in a plate-like form along a rail inner panel 7a of the vehicle body 7. The wall portion 31 has an attachment portion 32 into which the clip or the like 22 is inserted, so as to correspond to the attachment portion 21 of the airbag 20. For example, the bag cover 30 is fixed to and positioned relative to the vehicle body 7 by inserting the clip or the like 22 into the attachment portion 21 of the protrusion 23 and the attachment portion 32 of the bag cover 30, and inserting the clip or the like 22 into an attachment portion 7b which is a hole formed in the rail inner panel 7a, and fastening the airbag 20, the bag cover 30, and the vehicle body 7 together.

The ceiling panel 40 is a member that covers the airbag 20 attached to the bag cover 30 from the inner side of the vehicle. The surface of at least a part (specifically, lower portion) of the ceiling panel 40 is exposed to the inside of the vehicle. The ceiling panel 40 extends in a rail-like form along the edge portion of the vehicle ceiling 6 in the vehicle front-rear direction X. The ceiling panel 40 may be formed such that the front portion in the longitudinal direction is inclined downward from the rear side toward the front side, and the rear portion in the longitudinal direction is inclined downward from the front side toward the rear side, before the airbag 20 deploys and expands, similarly to the bag cover 30. The ceiling panel 40 forms a storage space 70 (see FIG. 6 to FIG. 8) for storing the airbag 20 between the bag cover 30 and the ceiling panel 40.

In the storage space 70, at least a part of various antenna wires and a wire harness in addition to the airbag 20 may be stored. In a case where the antenna wires and the like are stored in the storage space 70, the antenna wires and the like are preferably disposed above a position at which the airbag 20 is disposed and routed in the storage space 70 so as not to prevent deployment and expansion of the airbag 20.

The ceiling panel 40 is structured to be openable and closable with respect to the bag cover 30. The ceiling panel 40 is closed with respect to the bag cover 30 to close the storage space 70 before the airbag 20 deploys and expands. When the airbag 20 is stored in the storage space 70, the airbag 20 opposes a back surface of the ceiling panel 40 in which the back surface faces the storage space 70. The airbag 20 is brought into contact with the back surface of the ceiling panel 40 and presses the ceiling panel 40 toward the inside of the vehicle when the airbag 20 deploys and expands.

As described below in detail, the ceiling panel 40 is integrated with the bag cover 30 through the falling-off preventing structure 60. When the ceiling panel 40 is pressed toward the inside of the vehicle through deployment and expansion of the airbag 20, the ceiling panel 40 opens with respect to the bag cover 30 by using, as a pivot, a portion at which the ceiling panel 40 and the bag cover 30 are integrated. The opening operation is specifically rotation around the axis extending in the vehicle front-rear direction X through the portion at which the ceiling panel 40 is integrated with the bag cover 30. The ceiling panel 40 opens the storage space 70 and allows the airbag 20 in the storage space 70 to be exposed to the inside of the vehicle by the opening operation with respect to the bag cover 30, after the airbag 20 deploys and expands.

The ceiling panel 40 is integrated with the bag cover 30. The bag cover 30 and the ceiling panel 40 are integrally formed. Both the bag cover 30 and the ceiling panel 40 are formed of hard resin. A hard resin material in which the flexural modulus is, for example, 5,000 kg/cm² or more or 7,000 kg/cm² or more in a steady state, is used. Specifically, ABS, polycarbonate, acryl, polypropylene, or the like, is used. For example, PC-ABS (polycarbonate-ABS), TPO (olefin-based elastomer), or the like, is used.

The bag cover 30 and the ceiling panel 40 are lock-engaged with each other by the lock-engagement portion 50. Specifically, the lock-engagement portion 50 is an attachment portion for lock-engaging the bag cover 30 and the ceiling panel 40 with each other in a state where the ceiling panel 40 is closed with respect to the bag cover 30 to close the storage space 70. The lock-engagement portion 50 is disposed at the lower portions of the bag cover 30 and the ceiling panel 40. The lock-engagement portion 50 maintains the bag cover 30 and the ceiling panel 40 in a lock-engaged state after production of the vehicle 1. The lock-engagement by the lock-engagement portion 50 is released by a force generated when the airbag 20 deploys and expands.

For example, as shown in FIG. 4, the lock-engagement portion 50 includes a clip 51 disposed at one of the bag cover 30 and the ceiling panel 40 (the bag cover 30 in FIG. 4), and a clip seat 52 disposed at the other of the bag cover 30 and the ceiling panel 40 (the ceiling panel 40 in FIG. 4). In this case, the lock-engagement portion 50 allows the bag cover 30 and the ceiling panel 40 to be lock-engaged with each other by lock-engaging the clip 51 with the clip seat 52. The lock-engagement portions 50 are disposed at a plurality of portions (eight portions in FIG. 4, etc.) so as to be spaced from each other in the longitudinal direction of the bag cover 30 and the ceiling panel 40.

The falling-off preventing structure 60 is structured to prevent the ceiling panel 40 from falling from the bag cover 30. The falling-off preventing structure 60 is disposed between the bag cover 30 and the ceiling panel 40. The falling-off preventing structure 60 maintains connection between the bag cover 30 and the ceiling panel 40 also after lock-engagement between the bag cover 30 and the ceiling panel 40 by the lock-engagement portion 50 is released when the ceiling panel 40 opens with respect to the bag cover 30.

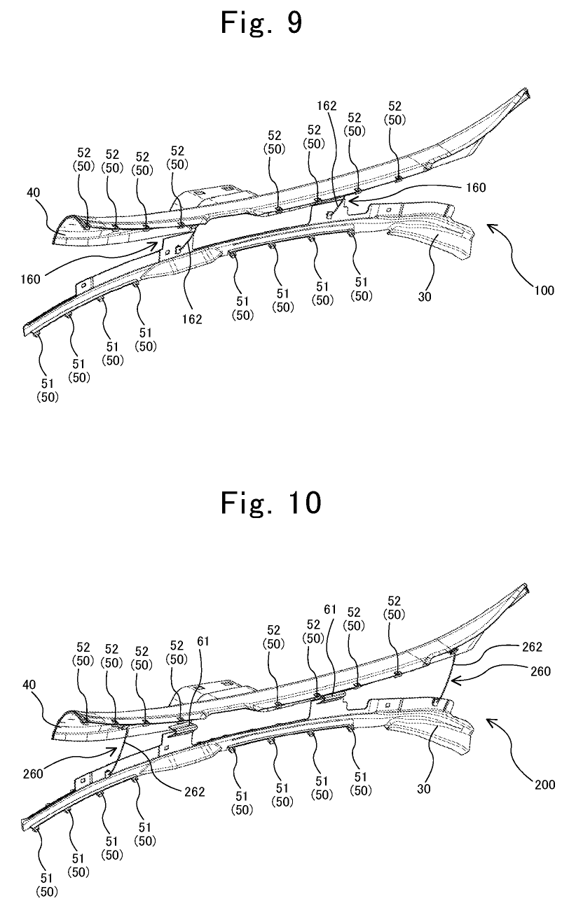

As shown in FIG. 6 and FIG. 8, the falling-off preventing structure 60 has a hinge portion 61. The hinge portion 61 is disposed between the bag cover 30 and the ceiling panel 40 and assists in opening of the ceiling panel 40 with respect to the bag cover 30. The hinge portion 61 acts as a pivot for the opening operation of the ceiling panel 40. As shown in FIG. 6, the hinge portion 61 is disposed at the upper portions of the bag cover 30 and the ceiling panel 40. The hinge portion 61 is disposed at least at or near the center portion of the ceiling panel 40 in the longitudinal direction. The hinge portion 61 is disposed at a position corresponding to the upper portion of the pillar 5A, 5B, 5C (at least the B pillar 5B). The hinge portion 61 maintains integration between the ceiling panel 40 and the bag cover 30 while preventing the ceiling panel 40 from falling from the bag cover 30 when the ceiling panel 40 opens with respect to the bag cover 30.

The hinge portion 61 is integrated with the bag cover 30 and the ceiling panel 40 and integrally formed with the bag cover 30 and the ceiling panel 40. The hinge portion 61 is formed into such a deformable and flexible shape as to prevent crack and damage from occurring while the ceiling panel 40 opens with respect to the bag cover 30. For example, the hinge portion 61 extends in a plate-like form in the longitudinal direction of the bag cover 30 and the ceiling panel 40 so as to have such a strength that the ceiling panel 40 is held by the bag cover 30 also after the opening operation of the ceiling panel 40. The hinge portions 61 are disposed at a plurality of portions (two portions in FIG. 4, etc.) so as to be spaced from each other in the longitudinal direction of the bag cover 30 and the ceiling panel 40. Specifically, the hinge portions 61 are disposed at two portions between which at least the B pillar 5B is disposed in the vehicle front-rear direction X.

A procedure for assembling the airbag structure 10 is described below. The airbag structure 10 is assembled in the following procedure. Firstly, the airbag 20, the bag cover 30, and the ceiling panel 40 which form the airbag structure 10 are prepared. At this time, the airbag 20 is formed so as to include the protrusion 23 having the attachment portion 21. The bag cover 30 and the ceiling panel 40 are integrally formed so as to include components of the lock-engagement portion 50 and components of the falling-off preventing structure 60.

Subsequently, the airbag 20 is attached to the bag cover 30 before the bag cover 30 and the ceiling panel 40 are lock-engaged with each other by the lock-engagement portion 50. This attachment is performed by inserting the clip or the like 22 through the attachment portion 21 of the airbag 20 and the attachment portion 32 of the bag cover 30. The attachment is performed to form the airbag structure 10 in which the airbag 20, the bag cover 30, and the ceiling panel 40 are modularized and integrated. A plurality of the attachment portions 21 of the airbag 20 may include the attachment portion 21 into which the clip or the like 22 is inserted without penetrating through the attachment portion 32 of the bag cover 30.

The above-described airbag structure 10 is fixed to the vehicle body 7 of the vehicle 1. This fixing is performed by inserting the clip or the like 22 protruding outward from the attachment portion 32 of the bag cover 30 of the airbag structure 10, into the attachment portion 7b of the rail inner panel 7a of the vehicle body 7, to hold and fix the airbag 20, the bag cover 30, and the rail inner panel 7a.

The lock-engagement between the bag cover 30 and the ceiling panel 40 by the lock-engagement portion 50 is preferably performed after the airbag 20 is stored in the storage space 70, and is more preferably performed after antenna wires and wire harnesses are stored. The lock-engagement by the lock-engagement portion 50 may be performed before the airbag structure 10 is fixed to the vehicle body 7, or after the airbag structure 10 is fixed to the vehicle body 7 and antenna wires and wire harnesses are thereafter routed.

An operation of the airbag structure 10 is described below. After the airbag structure 10 is fixed to the vehicle body 7, before collision of the vehicle 1, that is, before deployment and expansion of the airbag 20, as shown in FIG. 6 and FIG. 7, the bag cover 30 and the ceiling panel 40 are lock-engaged with each other by the lock-engagement portion 50, and the storage space 70 is maintained in a closed state.

When the airbag 20 deploys and expands from such a state due to collision of the vehicle 1, the airbag 20 in the storage space 70 is firstly brought into contact with the back surface of the ceiling panel 40, and presses the ceiling panel 40 toward the inside of the vehicle. When the lock-engagement between the bag cover 30 and the ceiling panel 40 by the lock-engagement portion 50 disposed at the lower portions of the bag cover 30 and the ceiling panel 40 is released by pressing the airbag 20 toward the ceiling panel 40, the ceiling panel 40 opens with respect to the bag cover 30 by using, as a pivot, the hinge portion 61 positioned at the upper portion as shown in FIG. 8, so that the airbag 20 is ejected from the storage space 70 and further deploys and expands toward the inside of the vehicle.

After the airbag 20 deploys and expands, the airbag 20 is inserted into a space between an occupant seated in the seat 2 and the side window 4 and the pillars 5A, 5B, 5C. Therefore, even if the occupant seated in the seat 2 sways relative to the vehicle 1 in the vehicle left-right direction during collision of the vehicle 1, the head of the occupant is mainly protected.

In the above-described airbag structure 10, the falling-off preventing structure 60 is disposed between the bag cover 30 and the ceiling panel 40. The falling-off preventing structure 60 maintains connection between the bag cover 30 and the ceiling panel 40, and prevents the ceiling panel 40 from falling from the bag cover 30 also after lock-engagement between the bag cover 30 and

the ceiling panel 40 by the lock-engagement portion 50 is released due to deployment and expansion of the airbag 20.

Therefore, in the airbag structure 10, during collision of the vehicle 1, when the ceiling panel 40 opens with respect to the bag cover 30 by deployment and expansion of the airbag 20, and the airbag 20 further deploys and expands from the storage space 70 toward the inside of the vehicle, the ceiling panel 40 is prevented from separating and falling from the bag cover 30. Therefore, when the ceiling panel 40 opens with respect to the bag cover 30, safety of an occupant is prevented from being compromised.

The above-described falling-off preventing structure 60 has the hinge portion 61 for assisting in opening of the ceiling panel 40 with respect to the bag cover 30, and the lock-engagement portion 50 for lock-engaging the bag cover 30 and the ceiling panel 40 with each other in a closed state of the ceiling panel 40. The hinge portion 61 is disposed at the upper portions of the bag cover 30 and the ceiling panel 40, and the lock-engagement portion 50 is disposed at the lower portions of the bag cover 30 and the ceiling panel 40.

In this configuration, when the ceiling panel 40 opens with respect to the bag cover 30, the ceiling panel 40 rotates around the axis extending in the vehicle front-rear direction X so as to lift the lower portion by using, as a pivot, the hinge portion 61 positioned at the upper portion. In this case, when the airbag 20 deploys and expands, the airbag 20 is ejected from the lower portion of the storage space 70 toward the inside of the vehicle, and is easily spread into a lower portion or an obliquely lower portion along the side window 4 and the pillars 5A, 5B, 5C. Therefore, after collision of the vehicle 1, the airbag 20 is allowed to quickly deploy and expand to a desired expanded state.

The hinge portion 61 is disposed at least at or near the center portion of the ceiling panel 40 in the longitudinal direction. In this configuration, the pivot for the opening operation of the ceiling panel 40 includes the center portion of the ceiling panel 40 in the longitudinal direction or a portion near the center portion of the ceiling panel 40 in the longitudinal direction. Therefore, the opening operation of the ceiling panel 40 during deployment and expansion of the airbag 20 is inhibited from becoming unbalanced in the vehicle front-rear direction X, and stability of the opening operation is enhanced.

The hinge portion 61 is disposed at a position corresponding to the upper portion of the pillar 5A, 5B, 5C (at least the B pillar 5B) of the vehicle 1, and the hinge portions 61 are disposed at two portions between which at least the B pillar 5B is disposed in the vehicle front-rear direction X. In this configuration, the pivot for the opening operation of the ceiling panel 40 includes the positions between which the B pillar 5B is disposed. Therefore, when the airbag 20 deploys and expands, the opening operation of the ceiling panel 40 is inhibited from becoming unbalanced in the vehicle front-rear direction X, and stability of the opening operation is enhanced.

The hinge portions 61 are disposed at a plurality of portions so as to be spaced from each other in the longitudinal direction of the bag cover 30 and the ceiling panel 40. In this configuration, the pivots for the opening operation of the ceiling panel 40 are disposed at a plurality of portions in the vehicle front-rear direction X, and thus, stability of the opening operation is enhanced.

In the airbag structure 10, before the airbag structure 10 is fixed to the vehicle body 7, the airbag 20, the bag cover 30, and the ceiling panel 40 are modularized and integrated. Antenna wires and wire harnesses may also be modularized. The modularized airbag structure 10 is fixed to the vehicle body 7. In this configuration, the components of the airbag structure 10 and the like need not be separately fixed to the vehicle body 7, so that the number of process steps of combining the airbag structure 10 with the vehicle body 7 is reduced. The combining operation need not be performed after the airbag structure 10 is fixed to the vehicle body 7, so that workability for the combining operation is enhanced.

In the airbag structure 10, in order to attach the airbag 20 and the bag cover 30 to the vehicle body 7, the clip or the like 22 is inserted into the attachment portion 21 of the airbag 20, the attachment portion 32 of the bag cover 30, and the attachment portion 7b of the vehicle body 7. In this configuration, the airbag 20, the bag cover 30, and the vehicle body 7 are fastened together by the clip or the like 22, so that assembly of the airbag structure 10 and combination with the vehicle body 7 are easily performed without increasing the number of process steps.

In the above-described embodiment, the bag cover 30, the ceiling panel 40, and the hinge portion 61 are integrally formed. However, the present disclosure is not limited thereto. The bag cover 30, the ceiling panel 40, and the hinge portion 61 may be separately formed, and thereafter, the bag cover 30 and the hinge portion 61 may be integrated with each other by welding, adhesion, or the like, and the ceiling panel 40 and the hinge portion 61 may be integrated with each other by welding, adhesion, or the like. In this modification, the hinge portion 61 may be formed of a material that is more flexible than those of the bag cover 30 and the ceiling panel 40.

In the above-described embodiment, the falling-off preventing structure 60 has the hinge portion 61 disposed between the bag cover 30 and the ceiling panel 40. However, the present disclosure is not limited thereto. The falling-off preventing structure may have a tether portion for connecting between the bag cover 30 and the ceiling panel 40. For example, the tether portion may be string-like or a band-like cloth, or a hook member made of nylon, or the like.

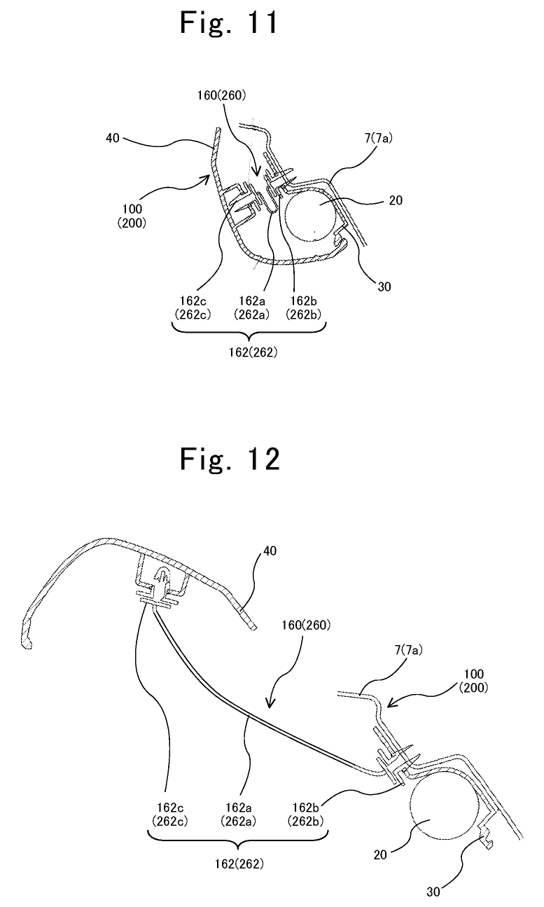

For example, an airbag structure 100 shown in FIG. 9 is achieved by using a falling-off preventing structure 160 instead of the falling-off preventing structure 60 in the airbag structure 10. The airbag structure 100 includes the falling-off preventing structure 160 for preventing the ceiling panel 40 from falling from the bag cover 30. The falling-off preventing structure 160 has a string-like tether portion 162. As shown in FIG. 11 and FIG. 12, the tether portion 162 is disposed between the bag cover 30 and the ceiling panel 40, and includes a string portion 162a and two clip portions 162b, 162c.

In this first modification, in the tether portion 162, one end of the string portion 162a is fixed to the clip portion 162b, and the other end of the string portion 162a is fixed to the clip portion 162c. The clip portion 162b is attached to the bag cover 30 and the vehicle body 7, and the clip portion 162c is attached to the ceiling panel 40. Also in the first modification, when the airbag 20 deploys and expands, also after the ceiling panel 40 opens with respect to the bag cover 30, connection between the bag cover 30 and the ceiling panel 40 is maintained by the tether portion 162, so that the ceiling panel 40 is prevented from falling from the bag cover 30.

For example, an airbag structure 200 shown in FIG. 10 is achieved by using a falling-off preventing structure 260 instead of the falling-off preventing structure 60 in the airbag structure 10. The airbag structure 200 includes the falling-off preventing structure 260 for preventing the ceiling panel 40 from falling from the bag cover 30. The falling-off preventing structure 260 has the hinge portion 61 similar to that in the embodiment, and a string-like tether portion 262. As shown in FIG. 11 and FIG. 12, the tether portion 262 is disposed between the bag cover 30 and the ceiling panel 40, and includes a string portion 262a and two clip portions 262b, 262c.

In this second modification, in the tether portion 262, one end of the string portion 262a is fixed to the clip portion 262b, and the other end of the string portion 262a is fixed to the clip portion 262c. The clip portion 262b is attached to the bag cover 30 and the vehicle body 7, and the clip portion 262c is attached to the ceiling panel 40. Also in the second modification, when the airbag 20 deploys and expands, also after the ceiling panel 40 opens with respect to the bag cover 30, connection between the bag cover 30 and the ceiling panel 40 is maintained by the hinge portion 61 and the tether portion 262, so that the ceiling panel 40 is prevented from falling from the bag cover 30.

In the above-described embodiment, the airbag structure 10 includes one bag cover 30 extending in a rail-like form along the edge portion of the vehicle ceiling 6. However, the present disclosure is not limited thereto. The airbag structure 10 may include a plurality of bag covers disposed so as to be spaced from each other in the longitudinal direction. That is, a plurality of bag covers may be disposed.

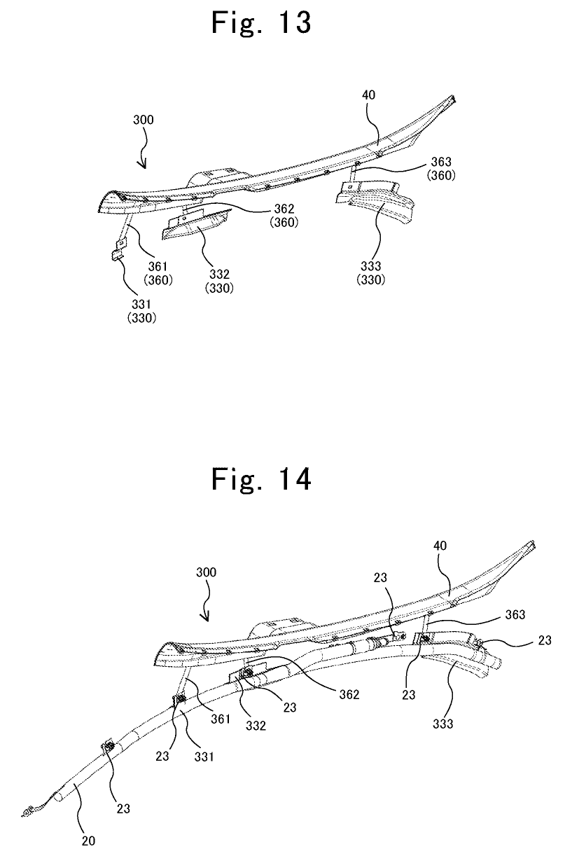

For example, an airbag structure 300 shown in FIG. 13 and FIG. 14 is achieved by using a bag cover 330 instead of the bag cover 30 in the airbag structure 10. The airbag structure 300 includes the bag cover 330 to which the airbag 20 is attached and which is fixed to the vehicle body 7. A plurality of the bag covers 330 (three in FIG. 13 and FIG. 14; bag covers 331, 332, 333) are disposed so as to be spaced from each other in the longitudinal direction.

In this third modification, the airbag structure 300 includes a falling-off preventing structure 360 for preventing the ceiling panel 40 from falling from the bag cover 330. A plurality of the falling-off preventing structures 360 (three in FIG. 13 and FIG. 14; falling-off preventing structures 361, 362, 363) are disposed so as to correspond to the plurality of the bag covers 330. The falling-off preventing structures 361, 362, 363 are implemented by hinge portions and tether portions. Also in the third modification, when the airbag 20 deploys and expands, also after the ceiling panel 40 opens with respect to the bag cover 330, connection between the bag cover 330 and the ceiling panel 40 is maintained by the falling-off preventing structure 360, so that the ceiling panel 40 is prevented from falling from the bag cover 330.

In the above-described embodiment, the airbag structure 10 includes one ceiling panel 40 extending in a rail-like form along the edge portion of the vehicle ceiling 6. However, the present disclosure is not limited thereto. The airbag structure may include a plurality of ceiling panels disposed so as to correspond to the plurality of bag covers as described above in the third modification.

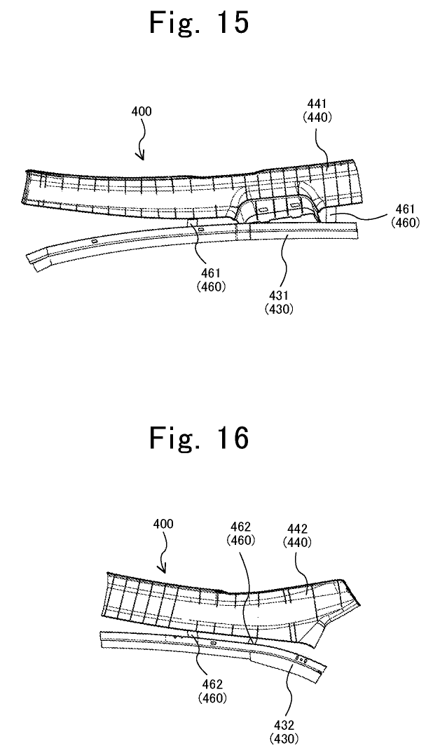

For example, an airbag structure 400 shown in FIG. 15 and FIG. 16 is achieved by using a bag cover 430 instead of the bag cover 30 and using a ceiling panel 440 instead of the ceiling panel 40 in the airbag structure 10. The airbag structure 400 includes a plurality of the bag covers 430 disposed so as to be spaced from each other in the longitudinal direction, and a plurality of the ceiling panels 440 disposed so as to correspond to the bag covers 430. The bag cover 430 includes two bag covers 431, 432 and the ceiling panel 440 includes two ceiling panels 441, 442.

In this fourth modification, the airbag structure 400 includes a falling-off preventing structure 460. A plurality of the falling-off preventing structures 460 (two in FIG. 15 and FIG. 16; falling-off preventing structures 461, 462) are disposed so as to correspond to the plurality of the bag covers 430 and the plurality of the ceiling panels 440. The falling-off preventing structures 461, 462 are implemented by hinge portions and tether portions. In a set of one bag cover 430 and one ceiling panel 440, the number of the falling-off preventing structures 460 may be one or more. Also in the fourth modification, when the airbag 20 deploys and expands, also after the ceiling panel 440 opens with respect to the bag cover 430, connection between the bag cover 430 and the ceiling panel 440 is maintained by the falling-off preventing structure 460, so that the ceiling panel 440 is prevented from falling from the bag cover 430.

In the above-described embodiment, the airbag structure 10 includes one airbag 20 extending in a rail-like form along the edge portion of the vehicle ceiling 6. However, the present disclosure is not limited thereto. The airbag structure 10 may be applied to a front seat airbag corresponding to an occupant seated in a front seat 2, and a rear seat airbag corresponding to an occupant seated in a rear seat 2.

That is, in the airbag structure 10, one airbag 20, one bag cover 30, and one ceiling panel 40 form one set, and two sets are separately and independently disposed for a front seat and a rear seat, respectively, in the vehicle front-rear direction X.

The present disclosure is not limited to the above-described embodiment and modifications, and various changes may be made without departing from the gist of the present disclosure. In addition, the present specification discloses not only the technical concept according to the citation relationship recited in the claims as originally filed, but also the technical concept obtained by combining the matters recited in the claims as appropriate.

The present application claims priority from Japanese patent application No. 2024-111348 filed on July 10, 2024, the entire contents of which are hereby incorporated by reference.

1. An airbag structure comprising:
an airbag;
a bag cover to which the airbag is attached, the bag cover being fixed to a vehicle body;
a ceiling panel integrated with the bag cover, the ceiling panel forming a storage space for storing the airbag between the bag cover and the ceiling panel, the ceiling panel opening the storage space by opening with respect to the bag cover, and exposing the airbag toward inside of a vehicle when the airbag deploys and expands; and
a falling-off preventing structure disposed between the bag cover and the ceiling panel, the falling-off preventing structure preventing the ceiling panel from falling from the bag cover.

2. The airbag structure according to claim 1, wherein the falling-off preventing structure has a hinge portion that assists in opening of the ceiling panel with respect to the bag cover.

3. The airbag structure according to claim 2, wherein the hinge portion is disposed at a position corresponding to an upper portion of a pillar of the vehicle.

4. The airbag structure according to claim 2, wherein
the bag cover and the ceiling panel extend in a rail-like form along an edge portion of a vehicle ceiling, and
the hinge portions are disposed at a plurality of portions so as to be spaced from each other in a longitudinal direction of the bag cover and the ceiling panel.

5. The airbag structure according to claim 1, wherein
the bag cover and the ceiling panel extend in a rail-like form along an edge portion of a vehicle ceiling, and
the airbag structure comprises lock-engagement portions disposed at a plurality of portions so as to be spaced from each other in a longitudinal direction of the bag cover and the ceiling panel, the lock-engagement portions lock-engaging the bag cover and the ceiling panel with each other in a closed state of the ceiling panel.

6. The airbag structure according to claim 1, wherein
a plurality of the bag covers are disposed so as to be spaced from each other in a longitudinal direction, and
a plurality of the falling-off preventing structures are disposed so as to correspond to the plurality of the bag covers.

7. The airbag structure according to claim 6, wherein a plurality of the ceiling panels are disposed so as to correspond to the plurality of the bag covers.

8. The airbag structure according to claim 7, wherein
the bag cover has a front-side bag cover disposed on a front side in the longitudinal direction and a rear-side bag cover disposed on a rear side in the longitudinal direction, and
the airbag has a front-seat airbag corresponding to the front-side bag cover and a rear-seat airbag corresponding to the rear-side bag cover.

9. The airbag structure according to claim 1, comprising an attachment portion configured to attach the airbag and the bag cover to the vehicle body.

10. The airbag structure according to claim 1, wherein the ceiling panel is formed of a hard resin.
